(19) United States
(12) Patent Application Publication
(10) Pub. No.: US 2006/0207093 A1
(43) Pub. Date: Sep. 21, 2006

(54) Cleaning and heating of iron liners for casting aluminum cylinder blocks

(76) Inventor: Robert J Bend, Plymouth, MI (US)

Correspondence Address: Cynthia S Murphy;Renner Otto Boisselle & Sklar, 1621 Euclid Avenue, 19th Floor, Cleveland, OH, 44115-2191, US

(21) Appl. No.: 10/546,560

(22) PCT Filed: Feb. 13, 2004
(86) PCT No.: PCT/AU04/00172

§ 371 Date: Aug. 24, 2005

(30) Foreign Application Priority Data
Feb. 14, 2003 (AU) 2003900666

(51) Int. Cl. B23P 11/00

(52) U.S. Cl. 29/888.061

(57) ABSTRACT

A method of providing an iron cylinder liner (1) for incorporation in a cast aluminium block for an internal combustion engine, including the steps of placing the liner (1) in a heated fluidised bed so as to simultaneously clean and heat the liner, and then positioning the cleaned and heated liner on the sand barrel core (2). The barrel core having been sized to accept the heated and thus expanded liner, which will subsequently cool and retract locking the liner onto the sand core in the correct position, in readiness for casting of the aluminium cylinder block.

### TECHNICAL FIELD

This invention relates to the pre-treatment of iron liners to be cast into aluminium cylinder blocks.

### BACKGROUND ART

It is common practice in the automotive and engine-manufacturing industry to, wherever possible, keep the weight of the component parts of a vehicle to a minimum. Thus while engine blocks were for long periods cast from cast iron, the cylinder bores were carefully machined to receive the pistons of the engine. However with the introduction of aluminium cylinder blocks, it is necessary to have in the cylinder block an iron cylinder liner in which the piston of the engine operates, due to the fact that aluminium is not a sufficiently wear resistant metal.

It is common practice to position the iron liners in the mould and cast the engine block so that the Iron liners are cast into position. However the liners must be thoroughly cleaned and preheated prior to contact with the molten aluminium metal.

As far as the applicant is aware the cleaning method most commonly employed involves shot blasting the liner with carbon steel shot. This is carried out in a shot blast cabinet, and this process is a difficult process to control based on the orientation of the liners in the shot blast cabinet.

The preheating of the liners is usually by induction heating, using an inductor placed within a void in the centre of the barrel core holding the liner.

The reason for pre-heating the liners prior to casting is to ensure that the lay-up (contact between the parent metal of the cylinder block and the liner) is as high as possible. If a liner is at ambient temperature then the hot liquid metal flowing over it will rapidly cool resulting in defects in the lay-up, these could manifest themselves as cold shuts (two liquid streams coming together but not fusing and leaving a fault line), and gas blows, which are a result of moisture turning to steam and forming a hole in the casting wall.

Because of the potential for heating the liner rapidly, usually within 10 seconds, induction heating is currently the preferred method for preheating the liners in casting operations.

Some of the problems associated with induction heating include:
The only control of liner temperature is via the power input to the inductors; no feasible process method is available to measure the liner temperature.
Lack of uniform heating of the liner, thermal imaging used to record the heating of the liners shows that the liners heat in a random fashion, temperature fluctuations in different areas of the same liner show 100° C. differentials with even greater differential on other liners in the same mould. This lack of temperature uniformity has a direct influence on the casting quality. With inconsistent liner temperatures effecting the solidification fronts resulting in shrink defects in the casting.
The liners are assembled in the mould at ambient temperatures. At low temperatures the liners are a good fit in the mould with potentially only 0.05 mm of movement. During the liner preheat which is normally in the range of 200° C. to 400° C. they expand exponentially. This expansion allows the liner internal diameter to grow leaving the barrel core that located it. This results in dimensional inaccuracies in the liner position, which is critical in aluminium cylinder block production. FIG. 1 shows the potential difference between ambient and elevated temperature liner position.

Fluidised beds are known to be used for heat treatment and also for the cleaning of articles.

It is the object of this invention to provide a solution whereby the problems of cleaning of a liner and the heating of the cylinder liner are overcome.

It is a further object of the invention to provide a means whereby the liner is uniformly preheated to a uniform temperature throughout the liner.

It is a further object of the invention to provide a means whereby the entire liner can be preheated to a selected temperature.

### DISCLOSURE OF THE INVENTION

In a preferred form of the invention there is provided a method of providing an iron cylinder liner for incorporation in a cast aluminium block for an internal combustion engine, including the steps of placing tho liner in a heated fluidised bed to simultaneously clean and heat the liner, and positioning the cleaned and heated liner in the sand core of the engine block prior to the casting of the aluminium cylinder block.

Preferably the fluidised bed is heated to the desired temperature.

Preferably the fluidised bed is a fluidised sand bed.

Preferably the sand core receiving the heated liner will be sized to accept the heated and thus expanded liner.

Preferably the subsequent cooling and resultant contraction of the liner will lock the liner onto the sand core in the correct position.

### BRIEF DESCRIPTION OF THE DRAWINGS

For a better understanding of this invention it will now be described with respect to the preferred embodiment which shall be described herein with the assistance of drawings wherein;

FIGS. 1 and 2 are cross sectional views of a heated liner seated upon a sand core sized and heated according to the methods of the prior art, illustrating the mismatch; and

FIG. 3 is a cross sectional view of a heated liner seated upon a sand core sized and heated according to the method of the present invention.

### BEST MODE FOR CARRYING OUT THE INVENTION

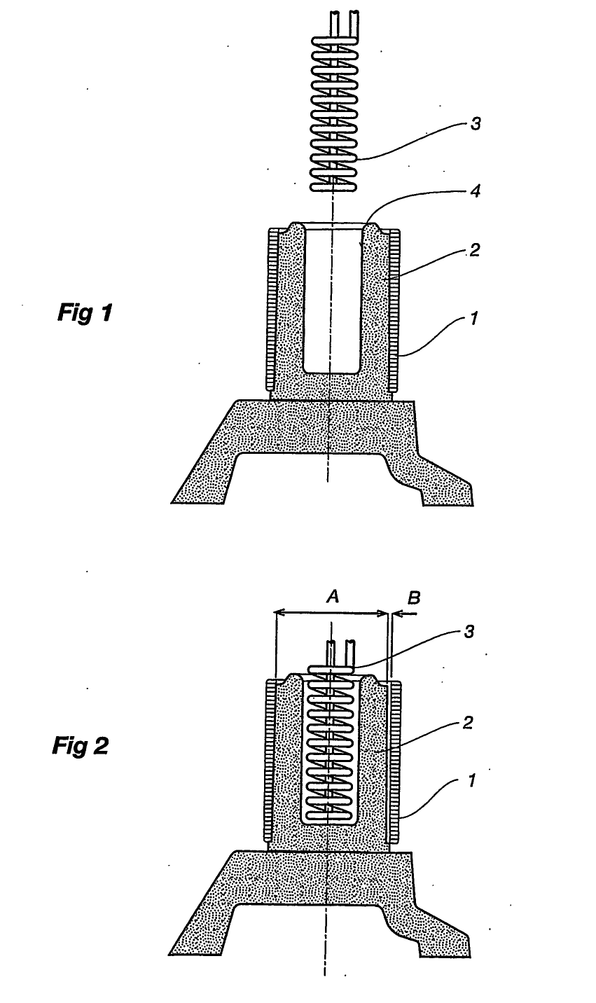

Now referring to the illustrations, and in particular to FIG. 1, there is a liner 1 which is to be heated according to the method of the prior art, namely by induction heating. The liner 1 has been seated upon the barrel core 2 at ambient temperature. At this low temperature the liner 1 is a good fit on the barrel core 2, with potentially only 0.05 mm of movement.

Referring now to FIG. 2, the liner is then preheated by an induction coil 3, which is lowered into a void 4 in the barrel core 2; during the liner preheat which is normally in the range of 200° C. to 400° C., the liner 1 expands exponentially. This expansion allows the liner internal diameter A to grow, leaving the barrel core 2 that located it. This could potentially result in a dimensional inaccuracy B, or even a misalignment in the liner 1 position, both of which are critical in aluminium cylinder block production.

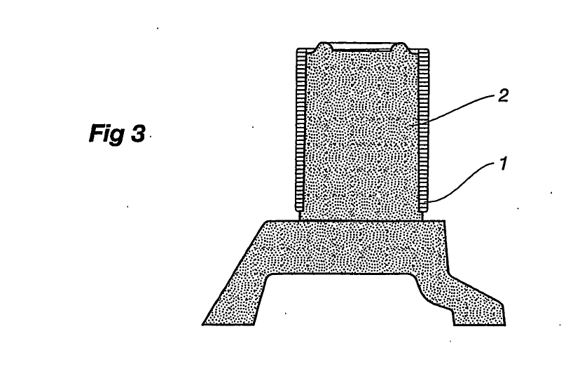

Referring now to FIG. 3, where the liner 1 is heated in a fluidised sand bed, and then placed upon the barrel core 2 by a programmable robot. In this case, the barrel core 2 has been sized to accept the heated and thus expanded liner. During the subsequent cooling and resultant contraction of the liner 1, it will lock the liner 1 onto the sand core 2 in the correct position.

It can be seen then that there are many benefits of using a fluidised sand bed for the heating and cleaning of the liners.

The fluidised bed will result in a scrubbing action on the liners, cleaning them, and by heating the fluidised bed to the required temperature the bed can be heated to +/−1° C. temperature control of the bed media. Anything in the bed will quickly homogenise to the bed temperature. Liners will heat without the differentials seen in induction heating, and the recorded temperature of the bed will be the temperature of the liner, making temperature control easier and more accurate.

The liners will then be taken from the bed preferably by robotic arms and assembled into the sand mould at the required temperature. Because the liner temperature is controlled its expansion will be known, and the sand core receiving the heated liner will be sized to the heated and thus expanded liner. The liner then cools, resulting in its contraction. This contraction will lock the liner onto the sand core in the correct position.

It is thus preferred that the moulds are cast as soon as possible after the liners are assembled into the mould, before the liners have cooled to any degree. Thus resulting in only minimal controlled losses of liner preheat temperature prior to the filling of the moulds. Furthermore, the increased accuracy in temperature control made possible by using fluidised beds makes it possible to compensate for any unwanted cooling in transfer operations by providing additional heating to the liner prior to transfer.

Since the fluidised bed pre-heat cleans all residues from the liner surface without undue wear (as in shot blasting), the liner castings can be reclaimed from un-cast packages and put through the system again.

Thus it can be seen by the invention that there is provided a system whereby articles can be simultaneously cleaned and heated. It is preferred the invention is particularly directed to the cleaning and heating of cylinder liners to be positioned in a sand mould for the casting of aluminium cylinder blocks.

Although one form of the invention has been described in some detail the invention is not to be limited thereto but can include variations and modifications falling within the spirit and scope of the invention

1. A method of providing an iron cylinder liner for incorporation in a cast aluminum block for an internal combustion engine, including the steps of placing the liner in a heated fluidised bed to simultaneously clean and heat the liner, and positioning the cleaned and heated liner in the sand core of the engine block prior to the casting of the aluminum cylinder block.

2. The method as set forth in claim 1 further characterized in that the fluidised bed is heated to the desired temperature.

3. The method set forth in claim 2 further characterized in that the fluidised bed is a fluidised sand bed.

4. The method set forth in claim 3 further characterized in that the sand core receiving the heated liner is sized to accept the heated and thus expanded liner.

5. The method set forth in claim 4 further characterized in that the subsequent cooling and resultant contraction of the liner will lock the liner onto the sand core in the correct position.

6. (canceled)

7. A method of making an engine block for an internal combustion engine, said method comprising the steps of:
placing a liner in a heated fluidised bed
placing the heated liner upon a barrel core corresponding to a bore for receiving the piston of the engine;
allowing the heated liner to cool on the barrel core to thereby lock the liner to the barrel core; and
casting the engine block about the barrel core and the liner locked thereto.

8. A method as set forth in claim 7, wherein the step of placing the liner in the heated fluidised bed results in the liner being simultaneously heated and cleaned.

9. A method as set forth in claim 7, wherein the liner is an iron cylinder liner.

10. A method as set forth in claim 7, wherein said casting step comprises casting an aluminum cylinder block.

11. A method as set forth in claim 7, wherein said step of placing the heated liner upon the barrel core is performed by robotic arms.

12. A method as set forth in claim 7, wherein the barrel core is a sand core.

13. A method as set forth in claim 7, wherein the temperature of the fluidised bed is the temperature of the liner.

14. A method as set forth in claim 7, wherein the barrel core is sized to receive the liner after it is removed from the fluidised bed.

15. A method of making an aluminum engine block having a cylinder piston-receiving bore, said method comprising the steps of:
placing a cylinder liner for the piston-receiving bore in a heated fluidised sand bath to uniformly preheat the entire liner to a selected temperature;
placing the preheated liner upon a sand barrel core sized to receive the liner when expanded at the selected temperature;
locking the liner into position on the sand core by allowing it to cool from the bath temperature and contract on the sand barrel core; and
casting the aluminum engine block about the barrel core and the liner locked thereto by filling a mould with hot liquid metal.

16. A method as set forth in claim 15, wherein the liner is an iron cylinder liner.

17. A method as set forth in claim 15, wherein the bath is at a bath temperature is selected to compensate for unwanted cooling during the placing step to insure that the preheated liner is at the selected temperature when placed upon the sand barrel core.

18. A method as set forth in claim 15, wherein said casting step is performed before the liner has cooled to a degree causing cold shuts and gas blows.

19. A method as set forth in claim 15, wherein the cylinder liner is also cleaned while in the heated fluidised sand bath.

20. A method as set forth in claim 19, wherein said cylinder liner is simultaneously cleaned and heated while in the heated fluidised sand bath.

21. A method as set forth in claim 20, wherein the liner is an iron cylinder liner.
